(19) United States
(12) Patent Application Publication
(10) Pub. No.: US 2025/0222877 A1
(43) Pub. Date: Jul. 10, 2025

(54) SLIDING CONNECTOR UNIT FOR VEHICLE

(71) Applicants: Hyundai Motor Company, Seoul (KR); Kia Corporation, Seoul (KR)

(72) Inventors: Yong Sik KIM, Seoul (KR); Dong Joo KIM, Seongnam-si (KR); In Ho JUNG, Seoul (KR)

(73) Assignees: Hyundai Motor Company, Seoul (KR); Kia Corporation, Seoul (KR)

(21) Appl. No.: 18/883,385

(22) Filed: Sep. 12, 2024

(30) Foreign Application Priority Data
Jan. 5, 2024 (KR) 10-2024-0002215

(51) Int. Cl. B60R 11/02; B60R 11/00; B60R 13/06; B60R 16/03

(52) U.S. Cl. CPC B60R 11/02; B60R 13/06; B60R 16/03; B60R 2011/0084; B60R 11/0217; B60R 11/0229

(57) ABSTRACT

A sliding connector unit for a vehicle includes a rail groove which extends in a longitudinal direction and which is formed in a vehicle panel, a vehicle electrode portion, and a connection portion including a first side inserted into the rail groove so that the connection portion is configured to be slid on the rail groove, including a second side exposed outside the vehicle panel, including a connector electrode portion provided on the first side of the connection portion inserted into the rail groove, and being configured so that the connector electrode portion is in contact with the vehicle electrode portion so that the connection portion is electrically connected to the vehicle electrode portion.

### CROSS REFERENCE TO RELATED APPLICATION

The present application claims priority to Korean Patent Application No. 10-2024-0002215, filed Jan. 5, 2024, the entire contents of which is incorporated herein for all purposes by this reference.

### BACKGROUND OF THE PRESENT DISCLOSURE

### Field of the Present Disclosure

The present disclosure relates to a sliding connector unit for a vehicle, the sliding connector unit being capable of being freely attached to or detached from an internal panel or an external panel of the vehicle, being capable of performing a sliding movement, being electrically connected to the vehicle, being capable of performing data communication, and being capable of utilizing various convenience devices.

### Description of Related Art

As an autonomous vehicle is developed and used, much research is being conducted on the utilization of space inside a vehicle beyond the concept that the vehicle is a simple means of transportation.

In a conventional vehicle, only convenience devices originally designed and manufactured were mounted in fixed positions. However, in an autonomous vehicle, as a movement range of a seat increases and a utilization range of the vehicle is diversified, the types of convenience devices required to be mounted or used are increased, so that mounting positions of the convenience devices are required to be diversified.

However, because it is impossible to mount a convenience device by anticipating innumerable demands, a technology in which a required device capable of being moved and capable of exchanging electric power or data between the vehicle and the device mounted at a required position in a vehicle is required for increasing convenience of a user.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a sliding connector unit for a vehicle, the sliding connector unit being configured for being freely attached to and detached from an internal panel or an external panel of the vehicle, being configured for performing a sliding movement, being electrically connected to the vehicle, and being configured for performing data communication, being configured for utilizing the various convenience devices.

To achieve the objectives described above, according to an exemplary embodiment of the present disclosure, there is provided a sliding connector unit for a vehicle, the sliding connector unit including: a rail groove which is recessed along a vehicle panel and which extends in a longitudinal direction of the vehicle panel; a vehicle electrode portion which is provided on an internal side surface of the rail groove, extends together with the rail groove in the longitudinal direction, and is electrically connected to a power source such as a battery of the vehicle; and a connection portion including a first side inserted into the rail groove so that the connection portion is configured to be slid on the rail groove, including a second side exposed outside the vehicle panel, including a connector electrode portion provided on the first side of the connection portion inserted into the rail groove, and being configured so that the connector electrode portion is in contact with the vehicle electrode portion so that the connection portion is electrically connected to the vehicle electrode portion.

The rail groove may be formed in an internal panel or an external panel of the vehicle.

A weatherstrip may be provided on the rail groove, the weatherstrip may cover the rail groove so that water is prevented from penetrating the rail groove, and the weatherstrip may extend in the longitudinal direction along the rail groove.

When the connection portion slides on the rail groove, the connection portion may be slid while deforming the weatherstrip.

A protrusion which is continuous may be formed in the rail groove, a catching portion may protrude on the connection portion, and the connection portion may be configured so that the connection portion slides while catching portion sequentially passes over the protrusion on the rail groove when the connection portion slides on the rail groove.

The protrusion of the rail groove may be formed so that the protrusion of the rail groove protrudes toward an internal space of the rail groove from an upper surface and a lower surface of the rail groove, and the catching portion of the connection portion may protrude toward outside from an upper surface and a lower surface of the connection portion, so that catching portion may face the protrusion of the rail groove.

The catching portion at upper and lower portions of the connection portion may be supported by an elastic portion so that the catching portion protrudes upward and downward of the connection portion.

The vehicle electrode portion may be provided on a bottom surface of the rail groove, and the connector electrode portion may be formed on a corresponding surface of the connection portion facing the bottom surface of the rail groove.

An entrance of the rail groove exposed on the vehicle panel may include a starting portion having a width greater than a width of the connection portion and may include an extension portion which extends from the starting portion and which has a width smaller than the width of the connection portion, the connection portion may be inserted into the rail groove through the starting portion, and the connection portion may be caught in the extension portion so that the connection portion is prevented from being separated while the connection portion is slid.

A starting portion of the rail groove may be formed as an inclined surface so that a depth of the rail groove is gradually deepened.

The connection portion may include an insertion portion which is inserted into the rail groove and which is provided with the connector electrode portion, an exposure portion positioned outside the rail groove, and a neck portion which is provided to penetrate an entrance of the rail groove and which connects the insertion portion and the exposure portion to each other.

The second side of the connection portion may be positioned outside the rail groove and a convenience device may be connected to the second side of the connection portion.

The convenience device may be configured for exchanging electric power or data with the vehicle through the connector electrode portion of the connection portion.

The convenience device may be any one of a holder, a controller, a lamp, a speaker, a storage box, and a display.

The vehicle panel may be any one of a door trim, a door panel, a fender panel, and a crash pad.

According to the sliding connector unit for the vehicle of the present disclosure, various convenience devices are configured for being freely attached to and detached from the internal panel or the external panel of the vehicle, are configured for being slidably moved, are configured for being electrically connected to the vehicle, and are configured for performing data communication, being configured for utilizing the various convenience devices.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1, FIG. 2, FIG. 3 and FIG. 4 are views exemplarily illustrating various cases in which a sliding connector unit for a vehicle according to an exemplary embodiment of the present disclosure is applied in the vehicle;

FIG. 5 is a view exemplarily illustrating a rail groove of the sliding connector unit for the vehicle according to an exemplary embodiment of the present disclosure;

FIG. 6 is a view exemplarily illustrating an electrical connection relationship of the sliding connector unit for the vehicle according to an exemplary embodiment of the present disclosure; and

FIG. 7 is a view exemplarily illustrating a fastening structure of the sliding connector unit for the vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments included in the present specification will be described in detail with reference to the accompanying drawings. In the present specification, the same or similar components will be denoted by the same or similar reference numerals, and a repeated description thereof will be omitted.

Detailed description of known technologies will be omitted if it is determined that the detailed description of the known technologies obscures the exemplary embodiments of the present specification. Furthermore, the accompanying drawings are merely intended to easily describe the exemplary embodiments of the present specification, but the spirit and technical scope of the present specification is not limited by the accompanying drawings. It should be understood that the present specification is not limited to specific disclosed exemplary embodiments of the present disclosure, but includes all modifications, equivalents and substitutes included within the spirit and technical scope of the present disclosure.

Terms including ordinals such as “first” or “second” used herein may be used to describe various elements, but the elements are not limited by the terms. The terms are used only for distinguishing one constituent element from another constituent element.

As used herein, the singular forms “a”, “an”, and “the” are intended to include the plural forms as well, unless the context clearly indicates otherwise.

It is to be understood that terms such as “including”, “having”, and the like are intended to indicate the existence of the features, numbers, steps, actions, elements, components, or combinations thereof disclosed in the specification, and are not intended to preclude the possibility that one or more other features, numbers, steps, actions, elements, components, or combinations thereof may exist or may be added.

In the following description, the expressions “module” and “portion” contained in terms of constituent elements to be described will be selected or used together in consideration only of the convenience of writing the following specification, and the expressions “module” and “portion” do not necessarily have different meanings or roles.

When a component is referred to as being “connected” or “contacted” to another component, it should be understood that it may be directly connected or contacted to the other component, but other components may exist therebetween. On the other hand, when a component is referred to as being “directly connected” or “directly contacted” to another component, it should be understood that there is no other component therebetween.

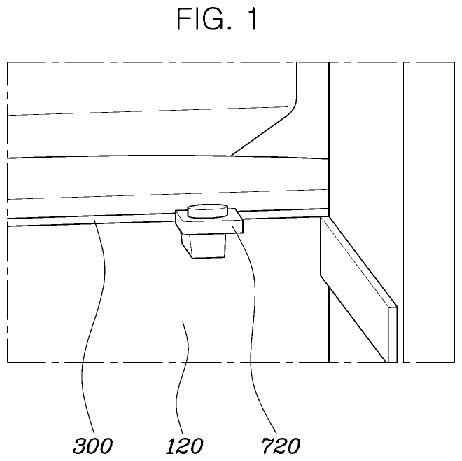

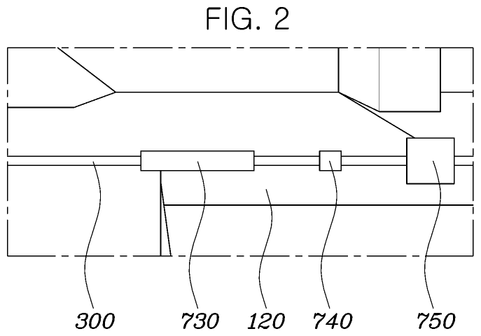

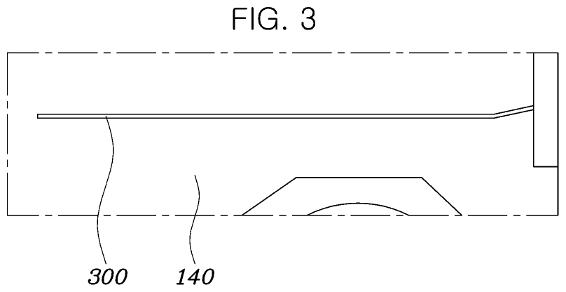

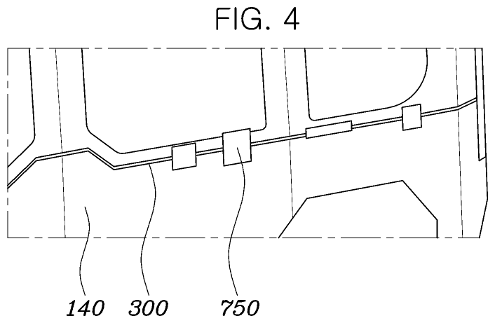

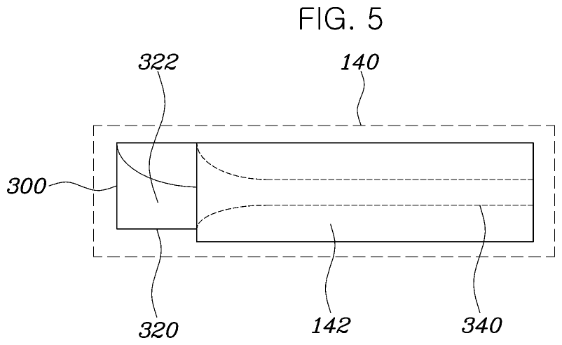

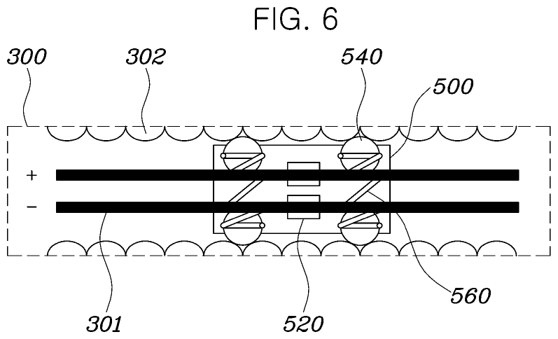

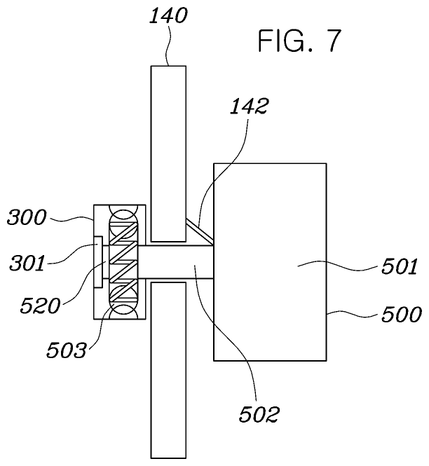

FIG. 1, FIG. 2, FIG. 3 and FIG. 4 are views exemplarily illustrating various cases in which a sliding connector unit for a vehicle according to an exemplary embodiment of the present disclosure is applied in the vehicle, FIG. 5 is a view exemplarily illustrating a rail groove of the sliding connector unit for the vehicle according to an exemplary embodiment of the present disclosure, FIG. 6 is a view exemplarily illustrating an electrical connection relationship of the sliding connector unit for the vehicle according to an exemplary embodiment of the present disclosure, and FIG. 7 is a view exemplarily illustrating a fastening structure of the sliding connector unit for the vehicle according to an exemplary embodiment of the present disclosure.

A sliding connector unit for a vehicle according to an exemplary embodiment of the present disclosure includes: a rail groove 300 which is formed by recessing vehicle panels 120 and 140 and which extends along a longitudinal direction thereof; a vehicle electrode portion 301 which is provided on an internal side surface of the rail groove 300, extends in the longitudinal direction together with the rail groove 300, and is electrically connected to a power source such as a battery of the vehicle; and a connection portion 500 including a first end portion inserted into the rail groove 300 so that the connection portion 500 is configured for being slid on the rail groove 300, including a second end portion exposed outside the vehicle panels 120 and 140, including a connector electrode portion 520 provided on the first side of the connection portion 500 inserted into the rail groove 300, and being configured so that the connector electrode portion 520 is in contact with the vehicle electrode portion 301 so that the connection portion 500 is electrically connected to the vehicle electrode portion 301.

The present disclosure is provided as a structure for mounting a convenience device necessary for the vehicle, the rail groove is formed in the vehicle, and the connection portion is provided in the convenience device. Furthermore, the connection portion of the convenience device is mounted in the rail groove of the vehicle, and is configured for being freely slid and a position of the connection portion is configured for being fixed at a required point, so that the convenience device is configured for being moved to a desired point in the vehicle and the convenience device is configured for being mounted on and fixed to the desired point.

Furthermore, there may be cases in which electric power is not required for the convenience device. However, when the convenience device requires electric power, the convenience device is configured for being operated by receiving electric power of the vehicle battery. Furthermore, electric power of the convenience device is configured for being transmitted to the vehicle. Furthermore, the vehicle and the convenience device are configured for transmitting and receiving data to/from each other, so that more various convenience devices may be mounted and utilized.

Accordingly, for exchanging power and data between convenience device and the vehicle, the vehicle electrode portion 301 is provided in the rail groove 300 of the vehicle, and the connector electrode portion 520 is provided in the connection portion 500. The vehicle electrode portion 301 is formed in a shape in which the vehicle electrode portion 301 extends together with the rail groove 300, and is positioned inside the rail groove 300, preventing a risk such as a short circuit in a normal situation. Furthermore, because the connector electrode portion 520 of the connection portion 500 is configured to be slidably moved while being in a state in which the connector electrode portion 520 is grounded with the vehicle electrode portion 301 of the rail groove 300, the convenience device and the vehicle may always be in an electrically connected state.

Of course, when an electrode is not provided in the connection portion 500, the vehicle is not electrically connected to the convenience device, and only a simple sliding function and a position fixing function are provided. Furthermore, in such a case, by opening a circuit of the vehicle electrode portion 301, an unnecessary risk such as a short circuit is prevented. The connection portion 500 is internally connected to the convenience device through an electrical circuit, various existing internal circuits may be used, and a detailed description of the connection portion 500 will be omitted.

FIG. 1, FIG. 2, FIG. 3 and FIG. 4 are views exemplarily illustrating various cases in which the sliding connector unit for the vehicle according to an exemplary embodiment of the present disclosure is applied in the vehicle. Firstly, FIG. 1 illustrates a case in which a convenience device is mounted in an internal space of the vehicle. As illustrated in FIG. 1, the rail groove 300 that extends in the longitudinal direction is formed in the internal panel 120 of the vehicle. Furthermore, various convenience devices 720 are mounted in the rail groove 300. In FIG. 1, an exemplary embodiment of the present disclosure, in which a cup holder 720 as a convenience device is mounted is illustrated. A general cup holder is not necessary to be connected through an electrode. However, when a cooling and heating cup holder is provided, the cooling and heating cup holder is configured for receiving electrical energy required for performing cooling and heating from the vehicle and also the cooling and heating cup holder is also configured for receiving a control signal from the vehicle because the vehicle electrode portion 301 and the connector electrode portion 520 are connected to each other.

In FIG. 2, a multi-controller 730, a speaker 740, and a lamp 750 that are provided in the internal panel 120 of the vehicle as convenience devices 720 are illustrated. A user may fasten a controller, a speaker, a lamp, and the like to the rail groove, and may slide the controller, a speaker, a lamp, and the like and then may fix the controller, a lamp, and the like to a desired Position thereof. Furthermore, such a controller, a speaker, a lamp, and the like are configured for being operated by use of electric power of the vehicle. The convenience device is required to be slidably moved. Furthermore, in considering a dangerous situation such as collision, the convenience device is also required to be fixed to the desired position.

FIG. 3 illustrates a case in which the rail groove 300 is formed on the external panel 140 of the vehicle. The rail groove 300 is configured for being mounted outside the vehicle because various convenience devices are configured for being mounted outside the vehicle and utilized. However, in the instant case, because the rail groove 300 is exposed to the external environment, reinforcement for water-tightness inside the rail groove 300 and the like will be required.

FIG. 4 illustrates a state in which the convenience device (the lamp 750) is mounted on the external rail groove 300 in FIG. 3. In FIG. 4, a case in which the lamp 750 and a speaker are mounted outside the vehicle as convenience devices, by installing the lamp and the speaker on the outside of the vehicle, activities such as advertising performed through the vehicle are configured for being realized, and the convenience devices are configured for being utilized during activities such as camping.

FIG. 5 is a view exemplarily illustrating the rail groove of the sliding connector unit for the vehicle according to an exemplary embodiment of the present disclosure.

The rail groove 300 may be formed in the internal panel 120 or the external panel 140 of the vehicle. The rail groove 300 is formed by recessing the panel of the vehicle, and extends in the longitudinal direction thereof. The connection portion 500 is mounted on the rail groove 300 and is configured to be slid. Furthermore, in a state in which the connection portion 500 is connected to the rail groove 300, it is required that the connection portion 500 does not be separated from the rail groove 300, and the connection portion 500 is required to be fixed at the required position thereof. To the present end, entrances 320 and 340 (a starting portion 320 and an extension portion 340) of the rail groove 300 exposed on the panel of the vehicle are formed of the starting portion 320 having a width greater than a width of the connection portion 500 and of the extension portion 340 which extends from the starting portion 320 and which has a width smaller than the width of the connection portion 500.

The rail groove 300 may be formed so that a width of an internal groove is uniform but a width at the entrance of the rail groove exposed externally varies according to points. The entrance exposed outside from the rail groove 300 may be formed of the starting portion 320 and the extension portion 340. As illustrated in the drawing, the starting portion 320 corresponds to the entrance of a point at which the rail groove 300 starts, and the extension portion 340 may be viewed as an entrance of a portion where the rail groove 300 extends. The extension portion 340 is formed in a slit shape that extends in the longitudinal direction when the extension portion 340 is viewed from the outside thereof. Furthermore, even when the width of the starting portion 320 and the width of the extension portion 340 are different from each other, the width of the groove formed therein is uniformly formed.

The connection portion 500 is initially inserted into the rail groove 300 through the starting portion 320. Therefore, because the starting portion 320 is formed so that the starting has a size slightly greater than a size of the connection portion 500, the user may easily insert the connection portion 500 into the starting portion 320, so that coupling between the connection portion 500 and the rail groove 300 is configured for being realized.

Furthermore, the connection portion 500 is inserted into the rail groove 300 through the starting portion 320, and the connection portion 500 may be prevented from being detached during sliding because the connection portion 500 is caught in the extension portion 340. The extension portion 340 extends from the starting portion 320, and the width of the extension portion 340 is smaller than the width of the connection portion 500, so that the connection portion 500 which is inserted into the rail groove 300 and which slides is not separated to the outside thereof. That is, the connection portion 500 is coupled to the rail groove 300 through the starting portion 320, and the connection portion 500 is configured for being separated from the rail groove 300 through the starting portion 320, so that the connection portion 500 is prevented from being separated from the rail groove 300 at a position where the connection portion 500 slides and used.

Furthermore, the starting portion 320 of the rail groove 300 may be formed as an inclined surface 322 so that a depth of the rail groove 300 is gradually deepened. Therefore, when the connection portion 500 is initially inserted into the rail groove 300, the connection portion 500 is naturally guided to the inside of the rail groove 300 through the inclined surface 322, and the connection portion 500 is configured for being slid inside the rail groove 300 without being caught in the extension portion 340.

Meanwhile, the vehicle electrode portion 301 is disposed inside the rail groove 300, so that a case in which foreign substances, water, and the like penetrate the vehicle electrode portion 301 and short circuit occurs is required to be prevented from occurring. When the rail groove 300 is formed on the external panel 140 of the vehicle, the vehicle electrode portion 301 inside the rail groove 300 is required to be protected from rain, wind, and the like according to weather. To the present end, a weatherstrip 142 is provided on the rail groove 300, the weatherstrip 142 covers the rail groove 300 to prevent water from penetrating the rail groove 300, and the weatherstrip 142 may extend in the longitudinal direction along the rail groove 300. Furthermore, when the connection portion 500 slides on the rail groove 300, the connection portion 500 slides while deforming the weatherstrip 142.

As illustrated in FIG. 5, the weatherstrip 142 is mounted above the rail groove 300, and covers the rail groove 300. The weatherstrip 142 is formed of a material such as rubber, and is formed so that a width of the weatherstrip 142 is wider than the entrance of the rail groove 300, so that the inside of the rail groove 300 is not exposed externally thereof. Through this, even when the rail groove 300 is formed on the external panel 140 of the vehicle, electrical failures such as short circuit do not occur in the vehicle electrode portion 301 inside the rail groove 300.

Furthermore, the weatherstrip 142 is formed of a material such as rubber and the like configured for being deformed. Therefore, when the connection portion 500 slides while the connection portion 500 is in a state in which the connection portion 500 is mounted in the groove 300, the connection portion 500 slides while deforming the weatherstrip 142. Furthermore, in a state in which the weatherstrip 142 is deformed, because the weatherstrip 142 covers a neck portion 502 of the connection portion 500 as illustrated in FIG. 7, the internal electrical connection portion may be protected.

FIG. 6 is a view exemplarily illustrating the electrical connection relationship of the sliding connector unit for the vehicle according to an exemplary embodiment of the present disclosure, and FIG. 7 is a view exemplarily illustrating the fastening structure of the sliding connector unit for the vehicle according to an exemplary embodiment of the present disclosure.

As illustrated in FIG. 7, the connection portion 500 may be formed of an insertion portion 503 inserted into the rail groove 300 and provided with the connector electrode portion 520, an exposure portion 501 positioned outside the rail groove 300, and the neck portion 502 which is provided to penetrate the entrance of the rail groove 300 and which connects the insertion portion 503 and the exposure portion 501 to each other. As discussed above, the width of the entrance where the rail groove 300 is exposed is smaller than the internal width of the rail groove 300. Therefore, in the connection portion 500, the insertion portion 503 is positioned inside the rail groove 300, and a width of the neck portion 502 is smaller than a width of the insertion portion 503 and the width of the neck portion 502 is equal to or smaller than the width of the entrance of the rail groove 300. Therefore, most of the insertion portion 503 of the connection portion 500 is not externally exposed and is covered by the panel of the vehicle, so that the structure inside the panel is protected.

Furthermore, the exposure portion 501 is connected to the neck portion 502 of the connection portion 500, and the connection portion 500 is fastened to the convenience device through the exposure portion 501, so that the mobility of the convenience device is configured for being secured and also the internal electrical connection is protected safely.

As illustrated in FIG. 6, the vehicle electrode portion 301 is provided on the internal side surface of the rail groove 300, the vehicle electrode portion 301 extends in the longitudinal direction along the rail groove 300, and the vehicle electrode portion 301 is electrically connected to the battery of the vehicle. Furthermore, the connector electrode portion 520 of the connection portion 500 is in contact with the vehicle electrode portion 301 and is electrically connected to the vehicle electrode portion 301. In the exemplary embodiment illustrated, the vehicle electrode portion is illustrated as two lines, +and −, but a line for data communication and the like may be added. Because the vehicle electrode portion 301 extends in the longitudinal direction of the rail groove 300, the connector electrode portion 520 always maintains contact with the vehicle electrode portion 301 regardless of where the connection portion 500 is positioned.

Furthermore, a plurality of protrusions 302 are continuously formed in the rail groove 300, and a catching portion 540 protrudes on the connection portion 500. Therefore, when the connection portion 500 slides on the rail groove 300, the connection portion 500 is configured for being slid while the catching portion 540 sequentially passes over the protrusion 302 of the rail groove 300.

The protrusion 302 of the rail groove 300 is formed so that the protrusion 302 of the rail groove 300 protrudes toward the internal space of the rail groove 300 from the upper surface and the lower surface of the rail groove 300, and the catching portion 540 of the connection portion 500 protrudes toward the outside from the upper surface and the lower surface of the connection portion 500, so that the catching portion 540 may face the protrusion 302 of the rail groove 300. Furthermore, the upper catching portion and the lower catching portion of the connection portion 500 may be supported by an elastic portion 560 (a spring 560) so that the upper catching portion and the lower catching portion of the connection portion 500 protrude upward and downward of the connection portion 500.

Through the present structure, when the connection portion 500 slides on the rail groove 300, the catching portion 540 is caught on the protrusion 302, and the connection portion 500 is temporarily fixed in stages. Furthermore, the catching portion 540 includes a structure configured for being retracted from inside the connection portion 500. Therefore, when the catching portion 540 is retracted, the catching portion 540 moves to the next protrusion 302, and the sliding is realized. In a normal situation, because the catching portion 540 is supported by the spring 560 so that the catching portion 540 protrudes outward, a position of the catching portion 540 is maintained when there is no external force. The elasticity of the spring 560 may be set appropriately as required.

Furthermore, the vehicle electrode portion 301 may be provided on a bottom surface of the rail groove 300, and the connector electrode portion 520 may be formed on a corresponding surface of the connection portion 500 facing the bottom surface of the rail groove 300. Furthermore, a second side of the connection portion 500 may be positioned outside the rail groove 300, and the convenience device may be connected to the second side of the connection portion 500. The convenience device is configured for exchanging electric power or data with the vehicle through the connector electrode portion 520 of the connection portion 500.

As an exemplary embodiment of the present disclosure, the convenience device may be any one of a holder, a controller, a lamp, a speaker, a storage box, and a display. Furthermore, the panel of the vehicle in which the rail groove is formed may be an internal panel such as a door trim and a crash pad, or may be an external panel such as a fender panel and a door panel.

According to the sliding connector unit for the vehicle of the present disclosure, various convenience devices are configured for being freely attached to and detached from the internal panel or the external panel of the vehicle, are configured for being slidably moved, are configured for being electrically connected to the vehicle, and are configured for performing data communication, being configured for utilizing the various convenience devices.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A sliding connector unit for a vehicle, the sliding connector unit comprising:
a rail groove which is recessed along a vehicle panel and which extends in a longitudinal direction of the vehicle panel;
a vehicle electrode portion which is provided on an internal side surface of the rail groove, extends together with the rail groove in the longitudinal direction, and is electrically connected to a power source of the vehicle; and
a connection portion including:
a first side inserted into the rail groove so that the connection portion is configured to be slid on the rail groove;
a second side exposed outside the vehicle panel;
a connector electrode portion provided on the first side of the connection portion inserted into the rail groove, and being configured so that the connector electrode portion is in contact with the vehicle electrode portion and the connection portion is electrically connected to the vehicle electrode portion.

2. The sliding connector unit of claim 1,
wherein the vehicle panel includes an internal panel and an external panel, and
wherein the rail groove is formed in at least one of the internal panel and the external panel of the vehicle.

3. The sliding connector unit of claim 1, wherein a weatherstrip is provided on the rail groove, covers the rail groove so that water is prevented from penetrating the rail groove, and extends in the longitudinal direction along the rail groove.

4. The sliding connector unit of claim 3, wherein the weatherstrip is mounted between the vehicle panel and the second side of the connection portion.

5. The sliding connector unit of claim 3, wherein, in response that the connection portion slides on the rail groove, the connection portion slides while deforming the weatherstrip.

6. The sliding connector unit of claim 1, wherein protrusions are continuously formed in the rail groove, a catching portion protrudes on the connection portion, and the connection portion is configured so that the connection portion slides while the catching portion sequentially passes over the protrusions on the rail groove in response that the connection portion slides on the rail groove.

7. The sliding connector unit of claim 6, wherein the protrusions of the rail groove are formed so that the protrusions of the rail groove protrude toward an internal space of the rail groove from an upper surface and a lower surface of the rail groove, and the catching portion of the connection portion protrudes toward outside from an upper surface and a lower surface of the connection portion, so that catching portion faces the protrusions of the rail groove.

8. The sliding connector unit of claim 7, wherein the catching portion at upper and lower portions of the connection portion is supported by an elastic portion so that the catching portion protrudes upward and downward of the connection portion.

9. The sliding connector unit of claim 1, wherein the vehicle electrode portion is provided on a bottom surface of the rail groove, and the connector electrode portion is formed on a corresponding surface of the connection portion facing the bottom surface of the rail groove.

10. The sliding connector unit of claim 1,
wherein an entrance of the rail groove exposed on the vehicle panel includes a starting portion having a width greater than a width of the connection portion and includes an extension portion which extends from the starting portion and which has a width smaller than the width of the connection portion, and
wherein the connection portion is inserted into the rail groove through the starting portion, and the connection portion is caught in the extension portion so that the connection portion is prevented from being separated while the connection portion is slid.

11. The sliding connector unit of claim 1, wherein a starting portion of the rail groove is formed as an inclined surface so that a depth of the rail groove is deepened.

12. The sliding connector unit of claim 1, wherein the connection portion includes:
an insertion portion which is inserted into the rail groove and which is provided with the connector electrode portion;
an exposure portion positioned outside the rail groove; and
a neck portion which is provided to penetrate an entrance of the rail groove and which connects the insertion portion and the exposure portion to each other.

13. The sliding connector unit of claim 1, wherein the second side of the connection portion is positioned outside the rail groove and a convenience device is connected to the second side of the connection portion.

14. The sliding connector unit of claim 13, wherein the convenience device is configured for exchanging electric power or data with the vehicle through the connector electrode portion of the connection portion.

15. The sliding connector unit of claim 13, wherein the convenience device is one of a holder, a controller, a lamp, a speaker, a storage box, and a display.

16. The sliding connector unit of claim 1, wherein the vehicle panel is one of a door trim, a door panel, a fender panel, and a crash pad.
